(19) United States
(12) Patent Application Publication
(10) Pub. No.: US 2024/0428484 A1
(43) Pub. Date: Dec. 26, 2024

(54) CAPTION DISPLAY CONTROL SYSTEM AND CAPTION DISPLAY CONTROL METHOD

(71) Applicant: SHARP KABUSHIKI KAISHA, Sakai City (JP)

(72) Inventors: RYOTA KAMEMOTO, Sakai City (JP); Haruka Okubo, Sakai City (JP); Takuto Sofue, Sakai City (JP); Eriko Hattori, Sakai City (JP); Kaoru Hori, Sakai City (JP); Takuro Mishima, Sakai City (JP); Hiroshi Uchiki, Sakai City (JP)

(21) Appl. No.: 18/744,758

(22) Filed: Jun. 17, 2024

(30) Foreign Application Priority Data
Jun. 21, 2023 (JP) 2023-101289
Mar. 29, 2024 (JP) 2024-055145

(51) Int. Cl. G06T 11/60; G06V 10/56; G06V 20/62

(52) U.S. Cl. CPC G06T 11/60; G06V 10/56; G06V 20/62

(57) ABSTRACT

A caption display control system comprises a display that displays content; a feature extractor that extracts a feature of the content; a display form determiner that determines a caption display form based on the content feature; and a display controller that displays the caption in the display in the display form determined by the display form determiner.

### CROSS-REFERENCE TO RELATED APPLICATION

The present application claims priority from Japanese Applications JP2023-101289 and JP2024-055145, the content to which is hereby incorporated by reference into this application.

### BACKGROUND OF THE INVENTION

### 1. Field of the Invention

The present disclosure relates to a caption display control system and a caption display control method.

### 2. Description of the Related Art

In general, caption display control systems that change display of captions based on a content sound signal have been proposed. For example, a caption display control system that determines a caption display method based on a sound feature extracted from a sound signal and superimposes a caption on a video using the determined display method has been proposed.

### SUMMARY OF THE INVENTION

However, when display of captions is changed based on a sound signal, a caption display form may not match atmosphere of a content image.

The disclosure is made in view of the above-mentioned problem. An object of the present disclosure is to provide a caption display control system and a caption display control method which are capable of displaying captions that match atmosphere of content.

According to an aspect of the present disclosure, a caption display control system includes a display that displays content, an image feature extractor that extracts a feature of the content, a display form determiner that determines a caption display form based on the content feature, and a display controller that displays the caption in the display in the display form determined by the display form determiner.

According to another aspect of the present disclosure, a caption display control method executed by a caption display control system includes extracting a feature of content, determining a caption display form based on the content feature, and displaying the caption in the display in the determined display form.

### BRIEF DESCRIPTION OF THE DRAWINGS

FIG. 1 is a block diagram illustrating a basic configuration of a caption display control system according to a first embodiment.

FIG. 2 is an example of a table stored in a storage of FIG. 1.

FIG. 3 is an example of another table stored in the storage of FIG. 1.

FIG. 4 is a flowchart of an example of a process executed by the caption display control system of FIG. 1.

FIG. 5 is an example of a table stored in the storage in a first processing example.

FIG. 6A is a diagram schematically illustrating a display image example of a caption on-screen.

FIG. 6B is a diagram schematically illustrating a display image example of a caption out-screen.

FIG. 7 is an example of a table stored in the storage in a second processing example.

FIG. 8 is an example of a table stored in the storage in a third processing example.

FIG. 9 is a block diagram illustrating a configuration of a caption display control system according to a second embodiment.

FIG. 10 is a diagram illustrating another method for providing content according to the second embodiment.

FIG. 11 is a block diagram illustrating a configuration of a caption display control system according to a third embodiment.

FIG. 12 is a diagram illustrating an example of an image indicated by an image signal.

FIG. 13 is a block diagram illustrating a configuration of a caption display control system according to a fourth embodiment.

### DETAILED DESCRIPTION OF THE INVENTION

Embodiments of the present disclosure will be described hereinafter with reference to the accompanying drawings. In the drawings, the same or equivalent components are denoted by the same symbols, and descriptions of the same or equivalent components are omitted without repeating them.

### First Embodiment/Configuration of Caption Display Control System

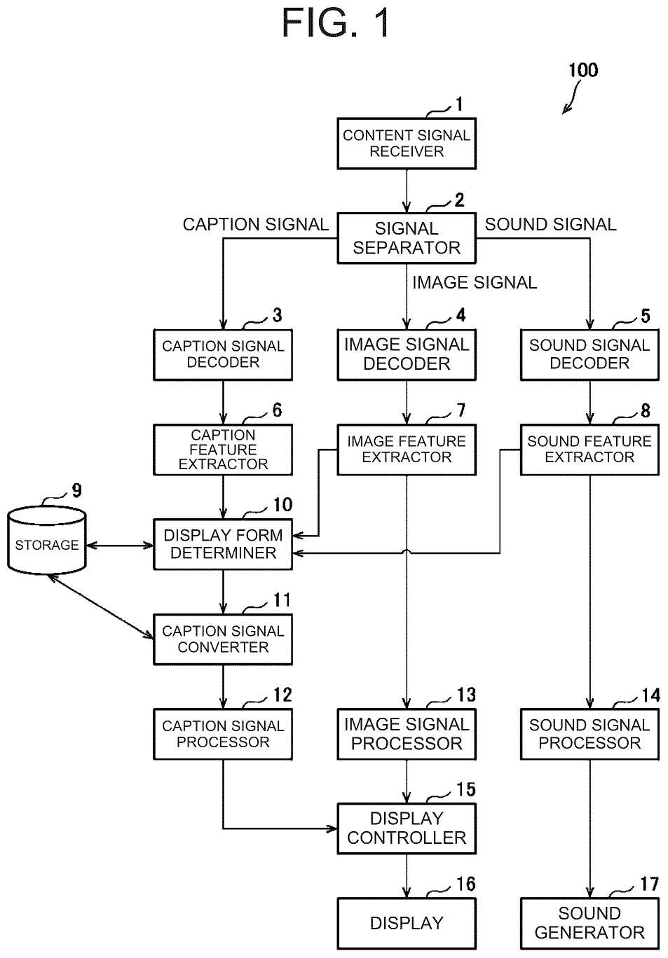

FIG. 1 is a functional block diagram illustrating a basic configuration of a caption display control system 100 according to a first embodiment. The caption display control system 100 may be implemented by one or more devices including some or all of functional blocks illustrated in FIG. 1. Specifically, the caption display control system 100 may be configured such that a single device includes all the functional blocks illustrated in FIG. 1 to constitute the single device. Alternatively, the caption display control system 100 may be implemented such that different devices include the different functional blocks illustrated in FIG. 1 so that all the functional blocks illustrated in FIG. 1 are included in an entire system configured by the plurality of devices. In this case, the plurality of devices are connected to one another in an information communication available manner.

The caption display control system 100 includes an arbitrary display device that displays content in a display, for example. Examples of the display device include, but are not limited to, a television receiver, a monitor, a display, a computer, a tablet terminal, a smartphone, and a projector.

Each of one or more devices included in the caption display control system 100 includes a controller, a storage, and a communicator. Each of one or more devices may further include functional sections other than the controller, the storage, and the communicator depending on functions of the devices.

The controller controls and manages the entire device including the functional sections of the device. The controller executes various controls, for example, by operating control programs stored in the storage. For example, the controller may be configured by a control device, such as a central processing unit (CPU) or a micro processing unit (MPU).

The storage is a storage medium capable of storing programs and data. The storage may be composed of, for example, a semiconductor memory or a magnetic memory. Specifically, the storage may be composed of, for example, an electrically erasable programmable read-only memory (EEPROM). The storage may store, for example, programs for operating the controller.

The communicator performs information communication with an external device. The communicator includes an appropriate interface in accordance with an information communication method. The device performs transmission and reception of data with the external device via the communicator.

As illustrated in FIG. 1, the caption display control system 100 includes, as the functional sections, a content signal receiver 1, a signal separator 2, a caption signal decoder 3, an image signal decoder 4, a sound signal decoder 5, a caption feature extractor 6, an image feature extractor 7, a sound feature extractor 8, a storage 9, a display form determiner 10, a caption signal converter 11, a caption signal processor 12, an image signal processor 13, a sound signal processor 14, a display controller 15, a display 16, and a sound generator 17. These functional sections are realized by the functional sections included in one or more devices. For example, the content signal receiver 1 is realized by the communicator of each of the one or more devices. For example, the storage 9 is realized by the storage of each of the one or more devices. For example, the signal separator 2, the caption signal decoder 3, the image signal decoder 4, the sound signal decoder 5, the caption feature extractor 6, the image feature extractor 7, the sound feature extractor 8, the display form determiner 10, the caption signal converter 11, the caption signal processor 12, the image signal processor 13, the sound signal processor 14, and the display controller 15 are realized by the controller of each of the one or more devices. The display 16 and the sound generator 17 are included in a display device which is one of the one or more devices.

The content signal receiver 1 receives a content signal transmitted from the external device. The content signal relates to information of content reproduced by the caption display control system 100.

In this embodiment, the content includes an image. Examples of the content include a video, a moving image, and a still image. Specifically, the content is a movie, a drama, a play, an animation, a computer game, or the like. However, the content is not limited to those exemplified here. The content may further include sound. In this embodiment, the content includes both an image and sound.

The content signal is generated by the external device which is a transmission source of the signal, for example. The external device generates a content signal by, for example, multiplexing a caption signal, an image signal, and a sound signal. Here, the caption signal, the image signal, and the sound signal relate to information on a caption, an image, and sound of the content, respectively. The external device transmits the content signal generated by the multiplexing to the caption display control system 100. The caption display control system 100 receives a content signal transmitted from the external device using the content signal receiver 1.

The signal separator 2 separates the multiplexed content signal into the original signals. In this embodiment, the signal separator 2 separates the content signal into the caption signal, the image signal, and the sound signal. Here, the caption signal, the image signal, and the sound signal obtained by the separation are supplied to the caption signal decoder 3, the image signal decoder 4, and the sound signal decoder 5, respectively.

The caption signal decoder 3, the image signal decoder 4, and the sound signal decoder 5 decode the caption signal, the image signal, and the sound signal, respectively. The decoded caption signal, the decoded image signal, and the decoded sound signal are supplied to the caption feature extractor 6, the image feature extractor 7, and the sound feature extractor 8, respectively.

A feature extractor including the caption feature extractor 6, the image feature extractor 7, and the sound feature extractor 8 extracts features of the content. Specifically, the caption feature extractor 6, the image feature extractor 7, and the sound feature extractor 8 extract features of a caption, an image, and sound, respectively. The caption feature extractor 6, the image feature extractor 7, and the sound feature extractor 8 extract features based on an algorithm determined in advance, for example.

The caption feature extractor 6 extracts a caption feature. For example, the caption feature extractor 6 extracts text data of a caption as a caption feature.

Furthermore, the caption feature extractor 6 extracts a specific character string included in the text data, for example, as a caption feature. The specific character string extracted by the caption feature extractor 6 is determined in advance and stored in, for example, the storage of the device. The caption feature extractor 6 can extract the specific character string stored in the storage by searching the text data for the specific character string.

The specific character string may be appropriately determined. The specific character string may indicate specific voice or specific sound, for example. As an example, the specific character string may indicate screaming or laughing. Examples of the character string representing screaming include “Argh” and “Oh”. Examples of the character string representing laughing include “Haha” and “Hehe”. However, the character strings representing screaming and laughing are not limited to the examples described herein. Furthermore, the specific character string is not limited to the character strings representing screaming and laughing. For example, the specific character string may be onomatopoeia including echoic words and mimetic words.

Furthermore, the caption feature extractor 6 extracts a description relating to sound included in the text data as a caption feature. Examples of the description relating to sound include text describing details of sound, such as sound of door open or close, sound of rain, sound of telephone bell, sound of thunder, and sound of sirens. The description relating to sound is represented by a specific form in the text data of the caption. As an example, the description relating to sound is represented using parentheses as a specific form. Specifically, the sound of door open or close is indicated as “(sound of door open or close)” in the text data of the caption. In this case, the caption feature extractor 6 can extract the description relating to sound by searching the text data for a portion indicated by the specific form.

Note that the caption feature extractor 6 may extract not only the specific character string and the description relating to sound but also other features that may be extracted from the caption signal as a caption feature.

The image feature extractor 7 extracts an image feature. For example, the image feature extractor 7 extracts image color information or a person or an object included in an image as an image feature.

The image color information is associated with colors included in an image, and is information on colors included in an entire image or a portion of an image, for example. The image feature extractor 7 can extract the color information as an RGB value, for example. For example, the image feature extractor 7 can extract an RGB value as an image feature by converting colors of the entire image into an RGB value using a color signal included in an image signal. The image feature extractor 7 can convert an image color into an RGB value by means of a general method.

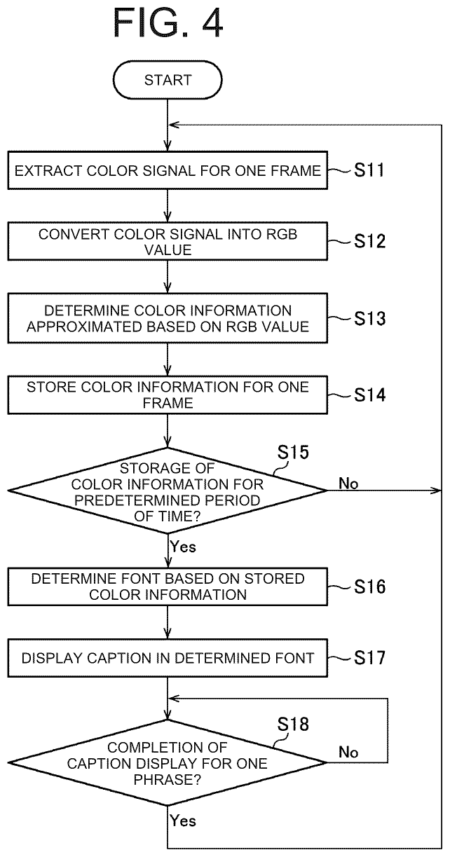

The color information may be indicated by a plurality of colors divided in advance. It is assumed that the color information is divided into 11 colors of red, orange, yellow, green, blue, purple, pink, brown, white, gray, and black. The image feature extractor 7 determines one of the 11 colors which is close to a color of an image, for example, based on an RGB value, and sets the determined color as image color information. The details of a method for determining image color information based on an RGB value will be described hereinafter with reference to FIG. 4. Note that the color information is not necessarily extracted as an RGB value or a plurality of colors, and may be extracted by, for example, a color tone or another index relating to a color.

A person or an object included in an image is information on a person or an object included in an image, and may be a person or an object itself or may include a motion of a person or an object. The image feature extractor 7 can extract a person or an object included in an image by means of a general image recognition technique. For example, the image feature extractor 7 identifies a person included in an image. The image feature extractor 7 may extract a motion of a mouth of a person included in an image. By extracting a motion of a mouth, a person (speaker) who is speaking in an image may be identified. The image feature extractor 7 may extract an expression of a person (speaker, for example) included in an image. The image feature extractor 7 may extract information obtained by discriminating an expression of a speaker between a cheerful expression and a moody expression. Furthermore, the image feature extractor 7 may extract a specific object included in an image, for example. The specific object to be extracted is determined in advance, for example, and stored in the storage of the device. The specific object may be, for example, a door, rain, a telephone, thunder, or a specific vehicle (for example, a police car, an ambulance, a fire engine, or the like), but is not limited thereto. For example, the image feature extractor 7 may extract a position of a person or an object included in an image as an image feature.

Note that the image feature extractor 7 may extract not only color information of an image and a person or an object included in an image but also other features that may be extracted from an image signal as an image feature. Furthermore, the image feature extractor 7 transmits an image signal to the image signal processor 13.

The sound feature extractor 8 extracts a sound feature. For example, the sound feature extractor 8 extracts a sound volume, a pitch of sound, a specific type of sound, and the like, as a sound feature.

The sound feature extractor 8 can extract a sound volume and a pitch of sound based on a sound waveform of a sound signal, for example. The sound feature extractor 8 may extract a result of a determination as to whether sound included in a sound signal is larger or smaller than a predetermined threshold value of a sound volume or a pitch of sound. The threshold value is determined in advance and stored in the storage of the device, for example.

Examples of the specific type of sound include speaking voice and sound generated by a specific object. Examples of the sound generated by a specific object include, but not limited to, sound of door open or close, sound of raining, sound of telephone bell, sound of thunder, and sound of sirens. The sound feature extractor 8 can extract the specific type of sound by means of a general sound recognition technique. The type of sound to be extracted by the sound feature extractor 8 is determined in advance and stored in the storage of the device, for example.

Furthermore, the sound feature extractor 8 can extract a length of a no-sound period as a sound feature. The sound feature extractor 8 can extract a length of a no-sound period based on a sound waveform of a sound signal, for example.

Note that the sound feature extractor 8 may extract not only the sound volume, the pitch of sound, the specific type of sound, and the length of the no-sound period but also other features that may be extracted from a sound signal as a sound feature. Furthermore, the sound feature extractor 8 transmits a sound signal to the sound signal processor 14.

The caption feature extractor 6, the image feature extractor 7, and the sound feature extractor 8 supply information on the extracted features to the display form determiner 10.

The storage 9 stores information required for determining a display form based on a feature. For example, the storage 9 stores a table indicating a correspondence relationship between a feature and a display form. Alternatively, the storage 9 stores an algorithm for determining a display form based on a feature.

Here, the feature is extracted by the caption feature extractor 6, the image feature extractor 7, or the sound feature extractor 8. The display form is a display form for captions. The caption display form includes at least one of a character size, a font, a color, and a display position of captions, for example. The following description will be made assuming that the caption display form includes a character size, a font, a color, and a display position of captions.

The elements relating to the caption display form are associated with specific features. For example, a character size is associated with a sound volume that is a sound feature, a font is associated with color information that is an image feature, a character color is associated with a facial expression of a speaker that is an image feature, and a display position is associated with a position of a person or an object included in an image that is an image feature. Note that the elements relating to the caption display form and association with the features are not limited to these.

The storage 9 stores a table indicating a correspondence relationship between a feature and a display form for each of the elements relating to the display form. For example, in the above-described example, the character size is associated with a sound volume which is a sound feature. In this case, the storage 9 stores a table indicating a correspondence relationship between a sound volume and a character size.

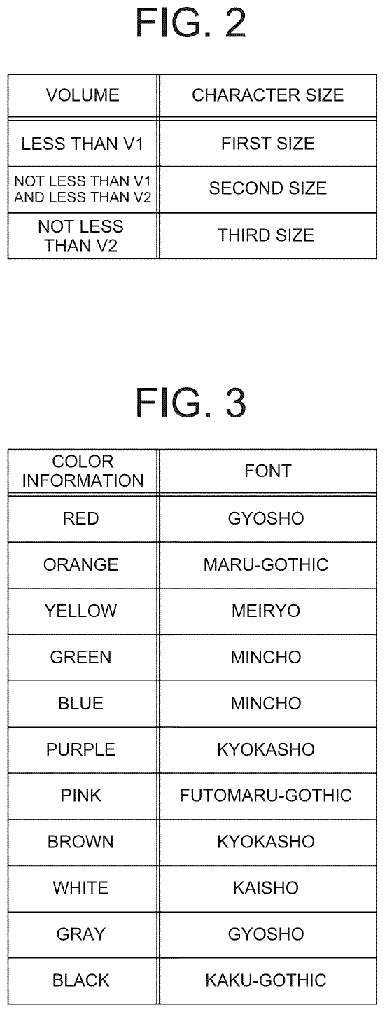

FIG. 2 is a diagram illustrating an example of a table stored in the storage 9. Specifically, a table indicating a correspondence relationship between a sound volume and a character size is illustrated in FIG. 2. In FIG. 2, the sound volume is classified into three stages of less than V1, V1 or more and less than V2, and V2 or more. Here, V1 and V2 are threshold values relating to a sound volume, and V1<V2 is satisfied. The values of V1 and V2 are determined in advance, for example. A first size, a second size, and a third size are associated as character sizes with the three stage classification of the sound volume. The first size, the second size, and the third size indicate character sizes and are represented by points of characters, for example. It is assumed here that the second size is larger than the first size and the third size is larger than the second size. As can be seen from the table of FIG. 2, the first size is associated with the sound volume less than V1, the second size is associated with the sound volume of V1 or more and less than V2, and the third size is associated with the sound volume of V2 or more. Specifically, as the sound volume increases, a larger character size is associated with the sound volume.

For example, in the above-described example, the font is associated with color information which is an image feature. In this case, the storage 9 stores a table indicating a correspondence relationship between color information and a font.

FIG. 3 is a diagram illustrating an example of another table stored in the storage 9.

Specifically, a table indicating a correspondence relationship between color information and a font is illustrated in FIG. 3. In FIG. 3, the color information is divided into 11 colors of red, orange, yellow, green, blue, purple, pink, brown, white, gray, and black. Fonts are associated with 11 color sections of the color information. In the table illustrated in FIG. 3, red and gray are associated with Gyosho script, orange is associated with round Gothic script, yellow is associated with Meiryo script, green and blue are associated with Mincho script, purple is associated with Kyokasho script, pink is associated with bold round Gothic script, brown is associated with Kyokasho script, white is associated with Kaisho script, and black is associated with square Gothic script.

The association between a color and a font is performed in advance, for example, based on an object imaged from each color and/or an image of each color itself. For example, objects, such as the sun, blood, a lipstick, and an apple, are imaged from the color red. Furthermore, for example, the color of red itself is associated with images of hot, bright, passionate, and dangerous. A font that matches such an object or image is associated with red. The same applies to the other colors. The association between a color and a font is performed in advance by, for example, an administrator of the caption display control system 100, a content provider, or the like using such a method.

Although the table indicating the correspondence relationship between a sound volume and a character size and the table indicating the correspondence relationship between color information and a font have been described in detail with reference to FIGS. 2 and 3, a similar table of the correspondence relationship between a facial expression of a speaker and a color of a character is stored in the storage 9. For example, a cold color is associated with a moody facial expression, and a warm color is associated with a cheerful facial expression.

As for a character display position, an algorithm for determining a character display position having a predetermined positional relationship with a speaker is stored in the storage 9. The predetermined positional relationship is, for example, such a relationship that a distance to the speaker is within a certain range. As the predetermined positional relationship, a distance to the speaker is preferably close. By reducing the distance to the speaker, when utterance content is displayed as a caption, a viewer can easily specify the speaker of the caption.

Referring back to FIG. 1, the display form determiner 10 determines a caption display form based on a content feature. In this embodiment, the display form determiner 10 determines the caption display form based on features extracted by the caption feature extractor 6, the image feature extractor 7, and the sound feature extractor 8. Specifically, the display form determiner 10 can determine a caption display form with reference to the storage 9.

For example, the display form determiner 10 determines a caption display form based on an image feature. As an example, the display form determiner 10 determines a font as a display form based on the color information serving as an image feature with reference to the table stored in the storage 9. Specifically, the display form determiner 10 determines a font corresponding to the color information as a caption display form with reference to the table illustrated in FIG. 3. Similarly, the display form determiner 10 can determine a color and a display position of text as a caption display form.

Furthermore, the display form determiner 10 may determine a caption display form based on another feature. For example, the display form determiner 10 can determine a character size as a display form based on a sound feature. Specifically, the display form determiner 10 determines a character size corresponding to a sound volume which is a sound feature as a caption display form with reference to the table illustrated in FIG. 2.

The display form determiner 10 may determine a caption display form based on a combination of a plurality of features. For example, the display form determiner 10 can determine a caption character size, a font, a color, and a display position as a caption display form based on an image feature and a sound feature.

The caption signal converter 11 converts caption text data into a form determined by the display form determiner 10. For example, data of characters of all character sizes, fonts, and colors to be used in the caption display control system 100 is stored in advance in the storage 9. The caption signal converter 11 converts caption text data to have a character size, a font, and a color determined by the display form determiner 10, by referring to the storage 9.

The caption signal processor 12 processes caption data converted by the caption signal converter 11 into a form displayable with an image. When a caption is to be superimposed on an image in display, for example, the caption signal processor 12 processes caption data converted by the caption signal converter 11 into a form in which the caption data can be superimposed on an image.

The image signal processor 13 generates an image to be displayed on the display 16 based on an image signal. For example, the image signal processor 13 processes an image signal into a form displayable on the display 16.

The sound signal processor 14 processes a sound signal into a form in which the sound signal can be output from the sound generator 17. For example, the sound signal processor 14 converts a sound signal, which is a digital signal, into an analog signal.

The display controller 15 displays an image and a caption on the display 16. Specifically, the display controller 15 displays an image and a caption on the display 16 based on an image signal processed by the image signal processor 13 and caption data processed by the caption signal processor 12. Here, the display controller 15 displays a caption on the display 16 in a display form determined by the display form determiner 10. The display controller 15 displays the caption superposed on the image on the display 16, for example.

The display 16 is a device that displays images. The display 16 may be composed of a well-known display, such as a liquid crystal display (LCD), an organic electro-luminescence display (OELD), or an inorganic electro-luminescence display (IELD). The display 16 displays various information under control of the display controller 15. For example, the display 16 displays content including an image and a caption under control of the display controller 15.

The sound generator 17 is a device that outputs sound. The sound generator 17 is composed of a speaker, for example. The sound generator 17 outputs sound of content, for example, under control of the sound signal processor 14.

Example of Process by Caption Display Control System Next, an example of a process executed by the caption display control system 100 will be described. FIG. 4 is a flowchart illustrating an example of a process of displaying a caption in a display form determined based on an image feature. FIG. 4 is a flowchart of an example of a process of determining a display form based on color information which is an image feature and displaying a caption in the determined display form.

In the flowchart illustrated in FIG. 4, the caption display control system 100 first determines color information of an image based on an RGB value. Specifically, the caption display control system 100 determines color information of an image in a process from step S11 to step S13.

Specifically, the image feature extractor 7 extracts a color signal for one frame of the image based on a decoded image signal (step S11). The image feature extractor 7 converts the extracted color signal for one frame into an RGB value (step S12). The RGB value for one frame of the image is thus extracted.

The image feature extractor 7 determines close color information for the image for one frame based on the extracted RGB value for one frame (step S13). For example, the image feature extractor 7 determines color information based on one of sections of the color information divided in advance which is close to the extracted RGB value for one frame. Since the color information is divided into 11 colors in the example described above, the image feature extractor 7 determines one of the sections of the 11 colors which is close to the extracted RGB value for one frame. For example, when the extracted RGB value for one frame is closest to an RGB value of red in the sections of the 11 colors, red is determined as the close color information.

Specifically, the image feature extractor 7 can determine the close color information with reference to the storage 9 in step S13. For example, the storage 9 stores predetermined RGB values for the sections of the 11 colors. The image feature extractor 7 determines color information having an RGB value which is closest to the extracted RGB value for one frame by comparing the extracted RGB value for one frame with RGB values of the sections of the 11 colors with reference to the storage 9. The color information having an RGB value which is closest to the extracted RGB value for one frame is determined as the color information close to the extracted RGB value for one frame. The comparison of the RGB values may be performed by comparison of individual numerical values of red (R), green (G), and blue (B), or may be performed based on a value calculated by performing predetermined numerical processing or weighting using the numerical values of red (R), green (G), and blue (B). Thus, the comparison of RGB values may be performed using one of a variety of comparison methods.

The image feature extractor 7 stores the color information for one frame determined in step S13 (step S14). For example, the image feature extractor 7 stores the color information for one frame determined in step S13 in the storage 9. In this case, the color information may be temporarily stored at least until a font is determined in step S16.

Thereafter, the image feature extractor 7 determines whether color information for frames corresponding to a predetermined period of time has been stored (step S15). The predetermined period of time can be set to an appropriate value in advance, that is, can be set in a range from one second to several seconds, for example. However, the predetermined period of time is not limited to the range described here. It is assumed here that the predetermined period of time is one second. Specifically, the image feature extractor 7 determines whether color information for frames corresponding to one second has been stored. A video for one second includes a plurality of frame images, for example. Therefore, the image feature extractor 7 determines whether color information has been stored by performing a process from step S11 to step S14 on images of a number of frames included in the video for one second.

When determining that color information for the predetermined period of time (one second in this case) has not been stored (No in step S15), the image feature extractor 7 executes the process from step S11 to step S14 on a next one frame following the frame in which the color information thereof has been stored in step S14. Thus color information for the next one frame is stored. The image feature extractor 7 repeatedly performs this process to store color information for the frames for the predetermined period of time.

When determining that the color information for the predetermined period of time has been stored (Yes in step S15), the image feature extractor 7 transmits the stored color information as an image feature to the display form determiner 10. The display form determiner 10 determines a caption display form based on the stored color information. In this embodiment, since the color information, that is, the image feature, is associated with a font which is a caption display form, the display form determiner 10 determines a font as a caption display form based on the stored color information (step S16).

Here, the display form determiner determines a caption display form with reference to the table stored in storage 9, for example. In this example, the display form determiner 10 determines a font as a display form with reference to the table indicating the correspondence relationship between color information and fonts as illustrated in FIG. 3, for example.

The display form determiner 10 can determine a font based on the stored color information by means of one of a variety of determination methods. For example, color information for a number of frames corresponding to one second is stored as the stored color information. The display form determiner 10 determines a font associated with a largest amount of color information in the stored color information corresponding to a number of frames for one second. For example, in the stored color information, it is assumed that the number of frames determined to be red is X, the number of frames determined to be orange is Y, and the number of frames determined to be yellow is Z. The display form determiner 10 determines a font associated with color information having the largest number of frames, among X, Y, and Z, as a caption display form. For example, X is larger than Y and Z, a font associated with red having the number of frames of X (Gyosho script in the example of FIG. 3) is determined as a caption display form. For example, Y is larger than X and Z, a font associated with orange having the number of frames of Y (round Gothic script in the example of FIG. 3) is determined as a caption display form. For example, Z is larger than X and Y, a font associated with yellow having the number of frames of Z (Meiryo script in the example of FIG. 3) is determined as a caption display form.

The display form determiner 10 may determine a font by another method. For example, a predetermined calculation may be performed based on color information of a number of frames for one second, and a font may be determined from information obtained as a result of the calculation. As an example, the display form determiner 10 performs weighting on the RGB values of red, orange, and yellow based on X, Y, and Z which are the respective numbers of frames, and determines a font based on resultant RGB values. In this case, a process of determining again color information close to the RGB values obtained as the result of the weighting and determining a font associated with the determined color information as a caption display form may be performed.

After the display form determiner 10 determines the font, the caption signal converter 11 and the caption signal processor 12 perform processes, and thereafter, the display controller displays a caption in the determined font in the display 16 (step S17).

The display controller 15 determines whether caption display for one phrase has been completed (step S18). The caption display for one phrase means a caption for one screen. That is, the caption display for one phrase means captions in a range before screen display is changed. For example, when a caption screen is changed once and different captions are displayed before and after the change, it means that the different captions for different phrases are displayed before and after the change.

When the caption display for one phrase has not been completed (No in step S18), the display controller 15 continues to display the same caption until the caption display for one phrase is completed. On the other hand, when the caption display for one phrase has been completed (Yes in step S18), the process proceeds to step S11 where the image feature extractor 7 extracts a color signal for a next one frame.

By this, since the process from step S11 to step S18 is repeatedly performed, the caption display control system 100 can determine a font based on color information which is an image feature and display a caption in the determined font. In particular, in the case of the example illustrated in the flowchart of FIG. 4, a font of captions is determined based on color information for a predetermined period of time (for example, one second) at the beginning of a video in which the captions are displayed. The captions are displayed in the determined font, and the display in the same font is continued without changing the font until the caption display for one phrase is completed in step S18. Therefore, it is easy to prevent a situation in which the captions become difficult to see due to frequent font changes.

However, the process in step S18 in the flowchart of FIG. 4 may not be executed. In this case, a caption font is determined based on color information of an image for a predetermined period of time, and the caption display is performed in the determined font. Therefore, the font can be changed in real time in accordance with a change in the image feature (color information).

Note that, although the example of the process of determining a font of a caption based on color information and displaying the caption in the determined font is described in FIG. 4, a process of determining another caption display form based on another feature and displaying a caption may be executed by a method based on the method in FIG. 4. For example, the caption display control system 100 may determine a character size based on a sound volume serving as a sound feature, determine a color of characters in a caption based on facial expression of a speaker serving as an image feature, and determine a caption display position based on a position of a person or an object included in an image serving as an image feature so as to display a caption in the determined form. Furthermore, the caption display control system 100 can determine individual elements of the caption display form based on the plurality of features, and can perform caption display by appropriately combining the elements. For example, the caption display control system 100 can display a caption using a character size determined based on a sound volume and a font determined based on color information. The same applies to the other combinations.

In this way, in the caption display control system 100 according to this embodiment, the display form determiner 10 determines a caption display form based on an image feature, and captions are displayed on the display 16 in the display form determined by the display form determiner 10. Therefore, captions that match atmosphere of content can be displayed based on the image feature.

The caption display control system 100 can display captions based on a feature by a method other than the method described in the embodiment or by another method in addition to the method described in the embodiment. Hereinafter, examples of other processes executed by the caption display control system 100 will be described.

### First Processing Example

In the caption display control system 100, the display form determiner 10 may determine a caption display form based on an image feature and a caption feature. Here, a case where a background color of an image is used as the image feature and a specific character string is used as the caption feature will be described.

An image background color means a color of a background of an image. As the image background color, for example, a color of a background portion obtained by removing a person from the image is used. Alternatively, the color information in the above embodiment may be used as the image background color. Accordingly, the image background color may be determined based on RGB values of the image or the background. The image background color is divided into a plurality of colors, for example. The image background color may be divided into sections of 11 colors, for example, as described in the foregoing embodiment. The image background color may be divided according to a criterion different from that in the division in 11 colors described in the foregoing embodiment. It is assumed here that the image background color is divided into two colors, that is, a bright background color and a dark background color. As a classification criterion of the bright background color and the dark background color, for example, RGB values for classification criteria stored in the storage 9 in advance are used.

The specific character string may indicate specific voice or specific sound, for example. It is assumed here that the specific character string indicates screaming voice or laughing voice. Character strings indicating screaming voice and laughing voice are defined in advance and stored in the storage 9, for example. As the character strings representing the screaming voice, for example, “Argh”, “Oh”, and the like are stored. As the character strings representing the laughing voice, for example, “Haha”, “Hehe”, and the like are stored.

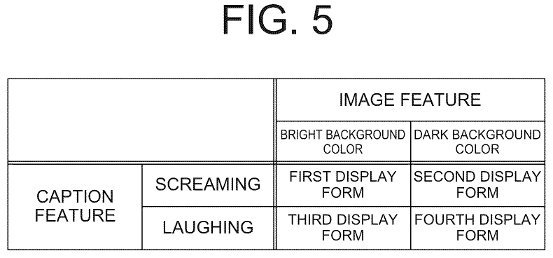

The storage 9 stores a table in which an image feature, a caption feature, and a caption display form are associated with one another, for example. FIG. 5 is an example of a table stored in the storage 9 in the first processing example. In the example illustrated in FIG. 5, a total of four display forms are defined depending on combinations of screaming voice and laughing voice, which are caption features, and the bright background color and the dark background color, which are image features. Specifically, a combination of the screaming voice and the bright background color is associated with a first display form. Similarly, a combination of the screaming voice and the dark background color is associated with a second display form, a combination of the laughing voice and the bright background color is associated with a third display form, and a combination of the laughing voice and the dark background color is associated with a fourth display form.

The first to fourth display forms are specific display forms associated with captions, and are defined according to at least one combination selected from a character size, a font, and a color of captions. The first to fourth display forms are determined in advance as display forms representing corresponding image features and corresponding caption features. The first display form associated with the combination of the screaming voice and the bright background color is, for example, a light font of white or yellow, which is associated with an enjoyable cheer. The second display form associated with the combination of the screaming voice and the dark background color is, for example, a blurred font of red or gray, which is associated with fear or sadness. The third display form associated with the combination of the laughing voice and the bright background color is, for example, a pop font of light blue or pink, which is associated with fun and gaiety. The fourth display form associated with the combination of the laughing voice and the dark background color is, for example, a grayish font of brown or black, which is associated with a chuckling laugh. Note that the display forms described here are merely examples, and the first to fourth display forms may be other appropriate display forms.

In the first processing example, the display form determiner 10 determines a caption display form based on an image feature and a caption feature. For example, the image feature extractor 7 determines whether an image has a bright background color or a dark background color as an image feature based on the RGB values for classification criteria stored in the storage 9. Furthermore, the caption feature extractor 6 determines whether a character string indicating screaming voice or laughing voice as a caption feature is included in a caption. For example, the display form determiner 10 determines a caption display form based on whether the image has a bright background color or a dark background color and whether the image includes screaming voice or laughing voice.

For example, when the image has a bright background color and includes a character string indicating screaming voice, the display form determiner 10 determines that a caption including the character string indicating screaming voice is displayed in the first display form with reference to the table of FIG. 5. For example, when the image has a dark background color and includes a character string indicating screaming voice, the display form determiner 10 determines that a caption including the character string indicating screaming voice is displayed in the second display form with reference to the table of FIG. 5. The same is applied to a case where a character string indicating laughing voice is included, and the display form determiner 10 determines that a caption is displayed in the third display form or the fourth display form based on whether the image has a bright background color or a dark background color. After the display form determiner 10 determines the display form, the caption signal converter 11 and the caption signal processor 12 perform processes, and thereafter, the display controller 15 displays the caption in the determined display form in the display 16.

The first to fourth display forms are determined based on a specific character string serving as a caption feature and a background color serving as an image feature, and therefore, captions are displayed after a caption display form is determined based on a caption feature and an image feature so that captions that match atmosphere of content may be displayed.

### Second Processing Example

In the caption display control system 100, the display form determiner 10 may determine a display form based on a category of content. The category of content is information that is assigned to content in advance and indicates classification of the content. Content may be appropriately categorized into, for example, “news/report”, “sports”, “information/tabloid show”, “drama”, “music”, “variety show”, “movie”, “animation/special effects”, “documentary/culture”, “theater/performance”, and “others”. Note that the categories described here are merely examples. Information on the category of the content is included in, for example, a multiplexed content signal. The display form determiner 10 can recognize the category of the content based on the information on the category included in the content signal.

The storage 9 stores a table in which content categories are associated with display forms that match images of the categories in advance. Here, the display form determiner 10 determines a caption display form using the category information with reference to the table stored in storage 9, for example. Note that the caption display forms may correspond to, but not limited to, caption fonts, for example.

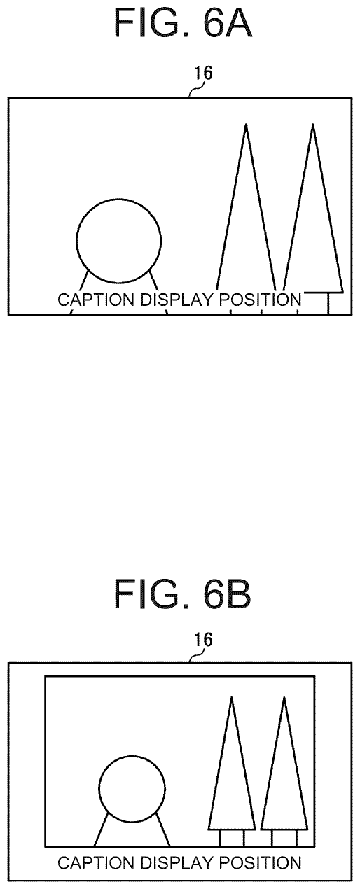

Furthermore, in the caption display control system 100, caption on-screen and caption out-screen may be alternatively selectable as a caption display method. Here, the caption on-screen is a display method of displaying an image of content on the entire display 16 (display screen) and displaying a caption superimposed on the image of the content, for example, as schematically illustrated in FIG. 6A. On the other hand, the caption out-screen is a display method of providing a dedicated region for displaying a caption in the display 16 (display screen) and displaying the caption of the content without being superimposed on an image, for example, as schematically illustrated in FIG. 6B. Note that, although the caption is displayed at a lower center of the display 16 in FIGS. 6A and 6B, a display position of the caption may not be the lower center of the display 16 and may be an upper portion, a left portion, or a right portion. The caption on-screen and the caption out-screen may be alternatively selected, for example, based on a predetermined operation input performed by the user viewing the content.

The display form determiner 10 can add animations (text animations) to a caption as a caption display form when the caption on-screen is selected depending on a category of content. The storage 9 stores a table in which content categories are associated with whether animations are to be added to captions in advance. The display form determiner 10 determines categories corresponding to captions to which animations are to be added with reference to the table.

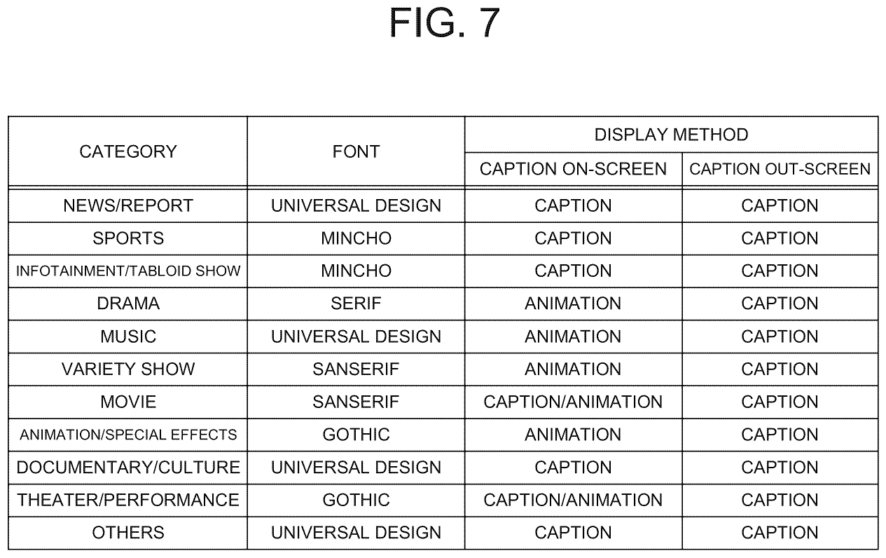

FIG. 7 is an example of the table stored in the storage 9 according to the second processing example. As illustrated in FIG. 7, the table stores a category, a font, and a caption display method in association with one another. The caption display method is a part of the caption display form, and in the example illustrated in FIG. 7, in the case of the caption on-screen and the caption out-screen, display of a caption in a caption form or a caption with animation added thereto is stored. That is, when “caption” is described in FIG. 7, text (characters) of a caption is displayed at a fixed position at a top, bottom, left, or right of the screen, for example, as a normal caption. On the other hand, when “animation” is described in FIG. 7, text of a caption is displayed on the display screen, for example, with an effect of animation in which a display position is appropriately changed or the caption is moved or enlarged/miniaturized. Note that one type of animation to be added may be determined in advance or may be determined by a predetermined determination method in accordance with text of the caption, for example.

For example, when a category of content is drama, a caption is displayed at a position close to a person who speeches words of the caption as animation. As a result, the person who speeches is clearly identified and realistic sensations may become high. Furthermore, for example, when a category of content is variety show, a caption is moved, enlarged, or miniaturized as animation to enhance fun of a program. In addition to the example described here, an atmosphere of the content can be more easily given to the user who is the viewer by adding an appropriate animation to the caption depending on a category of the content.

Note that, when “caption/animation” is described in FIG. 7, text of the caption is displayed at a fixed position as a normal caption or displayed with an effect of animation in accordance with content. For example, text of a caption of explanation is displayed as a normal caption and text of a caption of lines of a person is displayed with an effect of animation.

In the second processing example, the display form determiner 10 determines a font as a caption display form based on information on a category of content with reference to the table illustrated in FIG. 7. Furthermore, the display form determiner 10 determines a caption display method based on information on a category of content and a display method determined based on an input performed by the user (that is, the caption on-screen or the caption out-screen). For example, when the category is sports and the display method is caption on-screen, the display form determiner 10 determines a font to be “Mincho” and a display method to be “caption” with reference to the table of FIG. 7. For example, when the category is variety show and the display method is caption out-screen, the display form determiner 10 determines a font to be “Sanserif” and a display method to be “caption” with reference to the table of FIG. 7. For example, when the category is animation/special effects and the display method is caption on-screen, the display form determiner 10 determines a font to be “Gothic” and a display method to be “animation” with reference to the table of FIG. 7. After the display form determiner 10 determines the display form (font and display method), the caption signal converter 11 and the caption signal processor 12 perform processes, and thereafter, the display controller 15 displays the caption in the determined display form in the display 16.

By this, the caption is displayed in the font that matches an image of the content, and therefore, the caption that matches the atmosphere of the content can be displayed. Furthermore, in the case of caption on-screen, since animation is added to a caption depending on a category of content, an atmosphere of the content can be easily given to the user.

### Third Processing Example

In the caption display control system 100, the display form determiner 10 may replace, when an explanation of sound as a caption feature is included as a caption feature, the explanation of sound by characters representing the sound expressed by the explanation. The caption feature extractor 6 extracts the explanation of sound as a caption feature as described in the foregoing embodiment, for example.

The storage 9 stores a table in which an explanation of sound is associated with characters representing the sound expressed by the explanation in advance. The display form determiner 10 converts the explanation of extracted sound into characters representing the sound described in the table, for example.

Furthermore, the display form determiner 10 can change a display form of the characters representing the sound obtained by the conversion based on whether a sound source of the sound represented by the explanation of the sound is included in an image as an image feature. For example, the display form determiner 10 changes a display method as a display form based on whether a sound source is included in an image. Specifically, the display form determiner 10 displays the characters representing the sound as a normal caption or displays the characters with animation. Here, the display form determiner 10 can change a display form with reference to a predetermined table stored in storage 9, for example.

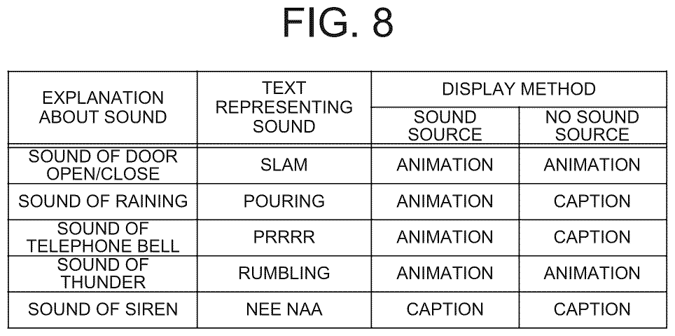

FIG. 8 is an example of the table stored in the storage 9 in the third processing example. As illustrated in FIG. 8, in the table, explanation of sound, characters representing sound, and a caption display method which are associated with one another are stored. The caption display method is a part of the caption display form, and in the example illustrated in FIG. 8, for a case of “sound source” indicating that a sound source is included in an image and in a case of “no sound source” indicating that a sound source is not included in an image, a display of a caption in a caption form or display of a caption displayed with animation added is stored.

In the third processing example, the display form determiner 10 replaces explanation of sound by characters representing the sound and in addition determines a caption display form based on the explanation of sound which is a caption feature and a result of a determination as to whether a sound source is included which is an image feature. It is assumed that the caption feature extractor 6 extracts a caption of explanation “sound of raining”. In this case, the display form determiner 10 replaces the caption “sound of raining” by a caption of characters “pouring” indicating sound with reference to the table illustrated in FIG. 8, for example. Furthermore, the image feature extractor 7 extracts whether or not “rain”, which is a sound source of the sound of raining, is included in the image in which the caption is displayed, as an image feature. When “rain” is included in the image, that is, in the case of presence of a sound source, the display form determiner 10 determines that animation is to be added to the caption of “pouring” obtained by the conversion as a caption display form. On the other hand, when “rain” is not included in the image, that is, in the case of absence of a sound source, the display form determiner 10 determines that the caption of “pouring” obtained by the conversion is to be displayed as a normal caption as a caption display form. When “animation” is added to the caption of “pouring”, the caption of “pouring” is moved on the display screen, for example.

It is assumed that the caption feature extractor 6 extracts a caption of explanation of “sound of telephone bell”. In this case, the display form determiner 10 replaces the caption “sound of telephone bell” by a caption of characters “prrrr” indicating sound with reference to the table illustrated in FIG. 8, for example. Furthermore, the image feature extractor 7 extracts whether or not “telephone”, which is a sound source of the sound of telephone bell, is included in an image in which the caption is displayed, as an image feature. When “telephone” is included in the image, that is, in the case of presence of a sound source, the display form determiner 10 determines that animation is to be added to the caption “prrrr” obtained by the conversion in display as a caption display form. In this case, the caption “prrrr” is displayed, for example, on the display screen so as to be arranged near the telephone being displayed. On the other hand, when “telephone” is not included in the image, that is, in the case of absence of a sound source, the display form determiner 10 determines that the caption “prrrr” obtained by the conversion is to be displayed as a normal caption as a caption display form. In this case, the caption “prrrr” is displayed, for example, at a lower center on the display screen.

By this, since the explanation about sound is replaced by the characters representing the sound in display, realistic sensations may be given to the user. Furthermore, since different display forms are employed depending on a result of the determination as to whether a sound source is included, a display form may be changed based on not only a caption feature but also an image feature.

Note that it is not necessarily the case that, in the table illustrated in FIG. 8, each explanation about sound is associated with only one characters representing sound, but may be associated with a plurality of characters representing sound. In this case, not only the explanation about sound which is a caption feature but also text representing sound may be determined based on an image feature.

For example, in the table illustrated in FIG. 8, text representing sound “nee naa” is associated with explanation about sound “sound of sirens”. However, characters “nee naa”, characters “woo”, and characters “clang” representing three types of sound may be associated with the explanation about sound “sound of sirens”. In this case, when the caption of the explanation “sound of sirens” is extracted as a caption feature, the display form determiner 10 further specifies a type of vehicle included in the image as an image feature. The display form determiner 10 determines “nee naa” as characters representing sound when the specified type of vehicle is an ambulance, and the caption of the explanation “sound of sirens” is converted into the caption “nee naa”. The display form determiner 10 determines “woo” as characters representing sound when the specified type of vehicle is a police car, and the caption of the explanation “sound of sirens” is converted into the caption “woo”. The display form determiner 10 determines “clang” as characters representing sound when the specified type of vehicle is a fire engine, and the caption of the explanation “sound of sirens” is converted into the caption “clang”.

As another example, when the caption of the explanation “sound of raining” is extracted as a caption feature, the display form determiner 10 10 obtains a type of raining in the image as an image feature. The display form determiner 10 may replace the caption of the explanation “sound of raining” by “drizzling”, “spitting”, “pouring”, “lashing”, or the like depending on a type of raining.

### Second Embodiment

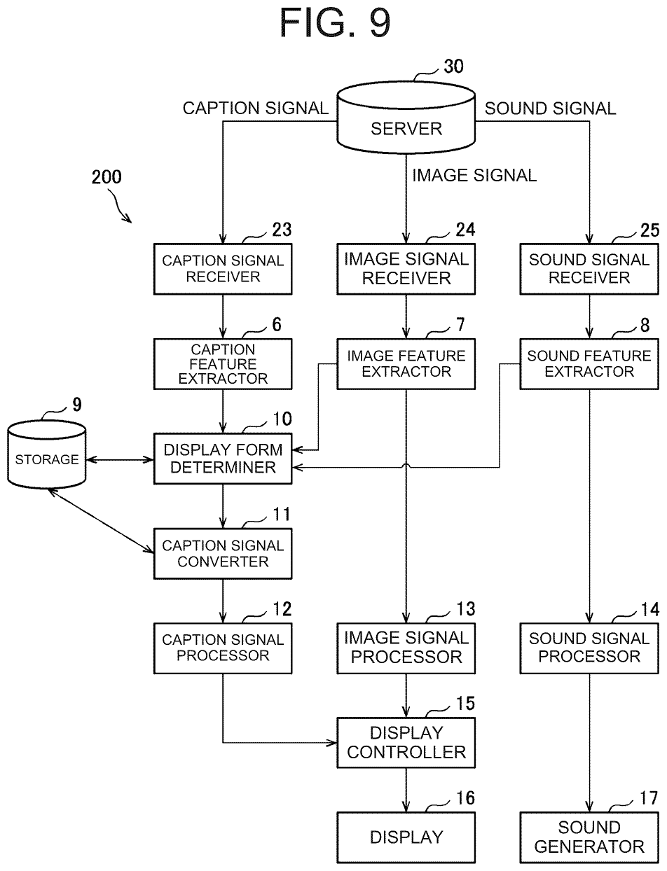

FIG. 9 is a block diagram illustrating a configuration of a caption display control system 200 according to a second embodiment. In the second embodiment, the same components as those in the first embodiment are denoted by the same reference numerals, and descriptions thereof are omitted.

As illustrated in FIG. 9, the caption display control system 200 according to the second embodiment is different from the caption display control system 100 according to the first embodiment in that the caption display control system 200 does not include the content signal receiver 1, the signal separator 2, the caption signal decoder 3, the image signal decoder 4, and the sound signal decoder 5. The caption display control system 200 according to the second embodiment includes a plurality of signal receivers which receive a caption signal, an image signal, and a sound signal of content, respectively. Specifically, as illustrated in FIG. 9, the caption display control system 200 includes a caption signal receiver 23, an image signal receiver 24, and a sound signal receiver 25.

In the second embodiment, a server 30 stores caption data, image data, and sound data of content. The server 30 transmits a caption signal, an image signal, and a sound signal indicating the caption data, the image data, and the sound data, respectively, to the caption display control system 200. The caption signal receiver 23 receives the caption signal supplied from the server 30. The image signal receiver 24 receives the image signal supplied from the server 30. The sound signal receiver 25 receives the sound signal supplied from the server 30. Specifically, the caption display control system 200 according to the second embodiment is different from the first embodiment in that the caption display control system 200 receives a caption signal, an image signal, and a sound signal, instead of a multiplexed content signal. The caption signal receiver 23 outputs the received caption signal to a caption feature extractor 6. The image signal receiver 24 outputs the received image signal to an image feature extractor 7. The sound signal receiver 25 outputs the received sound signal to a sound feature extractor 8. A process from here onward is the same as that of the first embodiment, and therefore, a detailed description thereof is omitted.

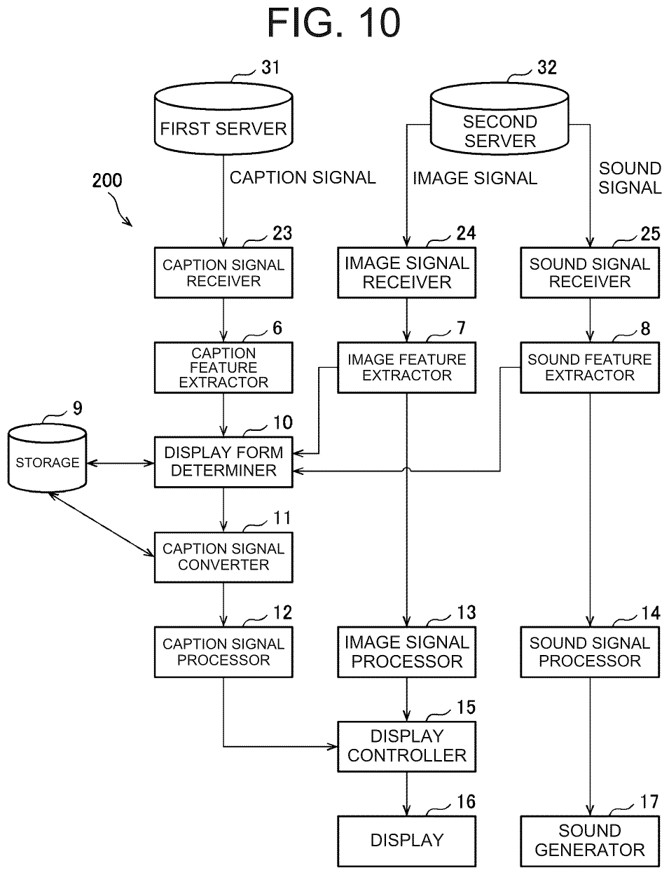

In the second embodiment, the individual signals of the content may not be supplied from the single server 30 to the caption display control system 200. The individual signals of the content may be supplied from two or more servers. For example, as illustrated in FIG. 10, the caption signal may be supplied from a first server 31, and the image signal and the sound signal may be supplied from a second server 32. In this case, the first server 31 stores caption data of the content, and the second server 32 stores image data and sound data of the content. A combination of the data stored in a plurality of data is not limited to the combination described above, and may be any combination. Alternatively, the individual signals of the content may be supplied from three or more servers.

### Third Embodiment

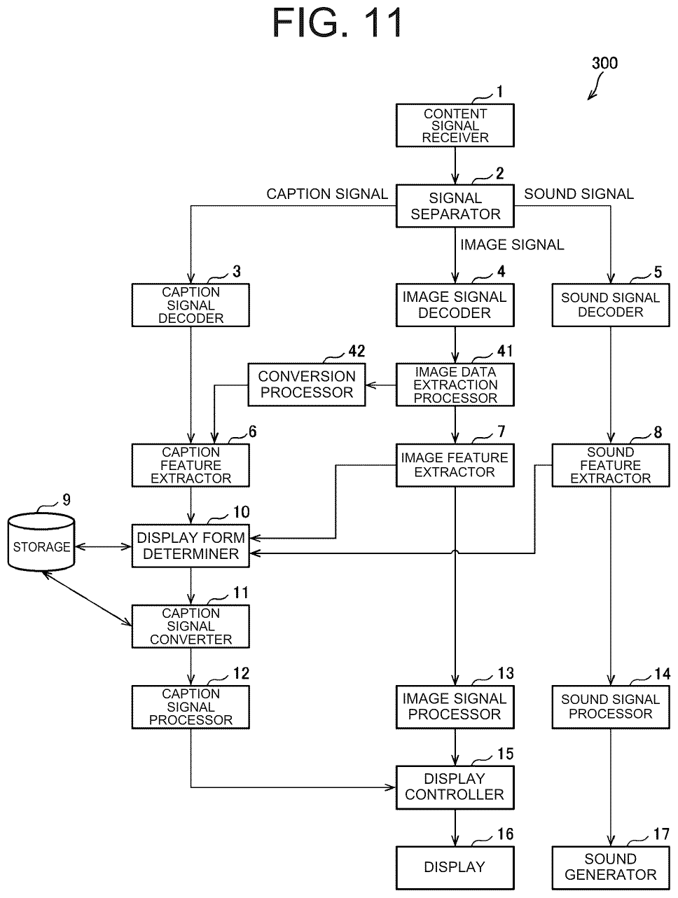

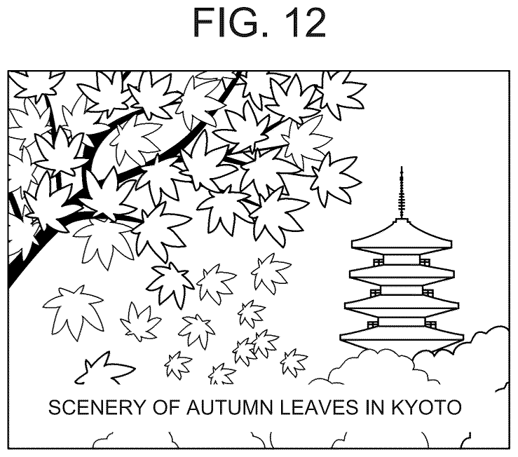

FIG. 11 is a block diagram illustrating a configuration of a caption display control system 300 according to a third embodiment. In the third embodiment, the same components as those in the first embodiment are denoted by the same reference numerals, and descriptions thereof are omitted.

As illustrated in FIG. 11, the caption display control system 300 according to the third embodiment includes, in addition to the functional sections of the caption display control system 100 according to the first embodiment, an image data extraction processor 41 and a conversion processor 42.

The image data extraction processor 41 obtained an image signal decoded by an image signal decoder 4. The image data extraction processor 41 extracts characters included in an image indicated by the image signal. For example, the image data extraction processor 41 extracts characters by extracting character information embedded in the image using a general image recognition technique. Since the image data extraction processor 41 extracts characters embedded in the image, the characters are not included in a caption indicated by a caption signal. Specifically, the image data extraction processor 41 extracts characters included as an image.

It is assumed that an image indicated by an image signal is as illustrated in FIG. 12. Characters “Scenery of Autumn Leaves in Kyoto” are embedded in this image. For example, the image data extraction processor 41 extracts characters “Scenery of Autumn Leaves in Kyoto” embedded in the image illustrated in FIG. 12 using a general image recognition technique. The image data extraction processor 41 inputs data on the extracted characters (here, the text “Scenery of Autumn Leaves in Kyoto”) to the conversion processor 42.

The conversion processor 42 converts the characters extracted by the image data extraction processor 41 into a caption signal. In this example, the conversion processor 42 converts data on the characters “Scenery of Autumn Leaves in Kyoto” obtained from the image data extraction processor 41 into a caption signal. The conversion processor 42 inputs the converted caption signal to a caption feature extractor 6.

A process executed by the caption feature extractor 6 onward is the same as that of the first embodiment. Specifically, the caption feature extractor 6 extracts a caption feature, and a display form determiner 10 determines a caption display form based on an image feature. In the third embodiment, the caption signal transmitted from the conversion processor 42 is processed in the same manner as the caption signal input from a caption signal decoder 3. Therefore, the display form determiner 10 determines a caption display form indicated by the caption signal converted by the conversion processor 42 based on an image feature, for example. A caption is displayed on the display 16 in the display form determined by the display form determiner 10.

Note that, in the third embodiment, an image signal processor 13 may perform image processing to remove the characters extracted by the image data extraction processor 41 in the image indicated by the image signal. That is, in the example illustrated in FIG. 12, in the image indicated by the image signal, the characters “Scenery of Autumn Leaves in Kyoto” are removed by the image signal processor 13, and instead, the characters “Scenery of Autumn Leaves in Kyoto” converted into the caption signal by the conversion processor 42 are displayed in the display form determined by the display form determiner 10.

### Fourth Embodiment

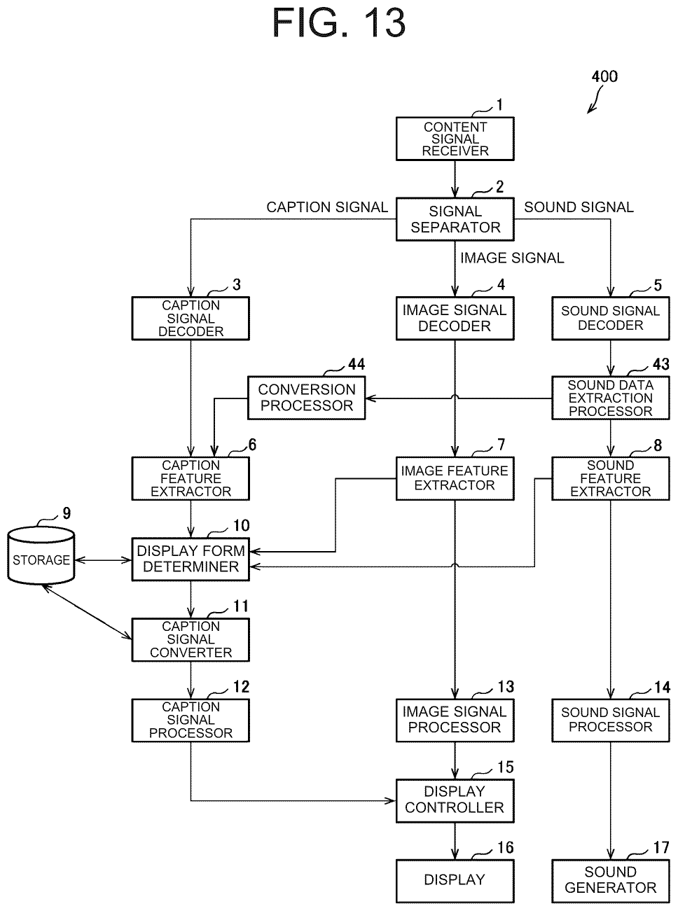

FIG. 13 is a block diagram illustrating a configuration of a caption display control system 400 according to a fourth embodiment. In the fourth embodiment, the same components as those in the first embodiment are denoted by the same reference numerals, and descriptions thereof are omitted.

As illustrated in FIG. 13, the caption display control system 400 according to the fourth embodiment includes, in addition to the functional sections of the caption display control system 100 according to the first embodiment, a sound data extraction processor 43 and a conversion processor 44.

The sound data extraction processor 43 obtained a sound signal decoded by a sound signal decoder 5. The sound data extraction processor 43 extracts sound indicated by the sound signal. For example, the sound data extraction processor 43 extracts sound by a general sound recognition technique.

It is assumed that the sound indicated by the sound signal includes a narration (speech) “Beautiful autumn leaves”. In this case, the sound data extraction processor 43 extracts the sound “Beautiful autumn leaves” using a sound recognition technique. The sound data extraction processor 43 inputs data on the extracted sound to the conversion processor 44.

The conversion processor 44 converts the sound extracted by the sound data extraction processor 43 into a caption signal. In this example, the conversion processor 44 converts data on the sound “Beautiful autumn leaves” obtained from the sound data extraction processor 43 into a caption signal. The conversion processor 44 inputs the converted caption signal to a caption feature extractor 6.

A process executed by the caption feature extractor 6 onward is the same as that of the first embodiment. Specifically, the caption feature extractor 6 extracts a caption feature, and a display form determiner 10 determines a caption display form based on an image feature. In the fourth embodiment, the caption signal supplied from the conversion processor 44 is processed in the same manner as the caption signal supplied from a caption signal decoder 3. Therefore, the display form determiner 10 determines a caption display form indicated by the caption signal converted by the conversion processor 44 based on an image feature, for example. A caption is displayed on the display 16 in the display form determined by the display form determiner 10.

In the embodiments and the other processing examples described above, although content of the tables may be set in advance and stored in the storage 9, the content of the tables may be set by a user performing a predetermined operation input. For example, in the table illustrated in FIG. 2, the user may freely set the relationship between a sound volume and a character size. Alternatively, in the table illustrated in FIG. 3, the user may freely set the relationship between color information and a font. Furthermore, for example, in the table illustrated in FIG. 8, the user may freely set characters indicating sounds corresponding to individual explanations about the sounds. For example, in the example of FIG. 8, although an explanation about sound “sound of telephone bell” is associated with characters indicating sound “prrrr”, the user may associate characters “ring”, instead of the characters “prrrr”, as the characters indicating sound. The same applies to the other tables.

As for a setting of the content of the individual tables stored in the storage 9 performed by the user, the user may set content that matches an image to the tables with reference to actual television broadcasting or the like or set preferred content to the tables. Alternatively, the user may set the tables by searching for or downloading desired font data, character colors, and onomatopoeia (text representing sound) via a network.

In the foregoing embodiment, the content signal is obtained by multiplexing the caption signal, the image signal, and the sound signal. However, the content signal may be obtained by multiplexing an arbitrary combination among the caption signal, the image signal, and the sound signal. Specifically, it is not necessarily the case that the content signal is obtained by multiplexing all the caption signal, the image signal, and the sound signal. In this case, the signal separator 2 separates the multiplexed content signal into the original signals.

Furthermore, in the foregoing embodiment, as for the association between an element relating to a caption display form and a feature, a character size is associated with a sound volume, a font is associated with color information, a character color is associated with a facial expression of a speaker, and a display position is associated with a position of a person or an object included in an image. However, the correspondence relationship between the elements relating to the caption display form and the features are not limited to this, and arbitrary correspondence relationship may be employed. Therefore, the display form determiner 10 can determine, based on the predetermined associations, using the caption feature, the image feature, or the sound feature, display forms associated with the features.

Although the disclosure has been described on the basis of the drawings and embodiments, it should be noted that a person having ordinary skill in the art can easily make various variations and modifications based on the disclosure. Accordingly, it should be noted that these variations and modifications are included within the scope of the disclosure. For example, the functions included in the respective functional parts or steps can be rearranged in a logically consistent manner, and multiple functional parts or steps can be combined into one or divided.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A caption display control system, comprising:
a display that displays content;
a feature extractor that extracts a feature of the content;
a display form determiner that determines a caption display form based on the content feature; and
a display controller that displays the caption in the display in the display form determined by the display form determiner.

2. The caption display control system according to claim 1, further comprising:
a signal separator that divides a multiplexed reception signal of the content into a caption signal, an image signal, and a sound signal, wherein
the feature extractor extracts a feature of an image as the content feature from the image signal, and
the display form determiner determines a display form of the caption included in the caption signal based on the image feature.

3. The caption display control system according to claim 2, wherein
the display form determiner determines the display form with reference to a table indicating correspondence relationship between the image feature and the display form set in advance based on the image feature.

4. The caption display control system according to claim 2, further comprising:
a sound feature extractor that extracts a sound feature of the content from the sound signal, wherein
the display form determiner determines the display form based on the image feature and the sound feature.

5. The caption display control system according to claim 1, wherein the display form includes at least one of elements selected from among a character size, a font, a color, and a display position of the caption.

6. The caption display control system according to claim 2, wherein the display form determiner determines a display position as the caption display form based on a position of a sound source serving as the image feature.

7. The caption display control system according to claim 2, further comprising:
a caption feature extractor that extracts a caption feature of the content from the caption signal, wherein
the display form determiner determines the display form based on the image feature and the caption feature.

8. The caption display control system according to claim 7, wherein the display form determiner determines, when a specific character string is included in the caption as the caption feature, the display form based on color information of the image serving as the image feature.

9. The caption display control system according to claim 1, wherein the display form determiner determines a font as the display form based on a category of the content.

10. The caption display control system according to claim 1, wherein
caption on-screen for displaying the caption superimposed on the image and caption out-screen for displaying the caption without being superimposed on the image is alternatively selected as a display method of the caption, and
the display form determiner adds animation to the caption as the display form when the caption on-screen is selected depending on a category of the content.

11. The caption display control system according to claim 2, further comprising:
a caption feature extractor that extracts a caption feature of the content from the caption signal, wherein
when explanation about sound is included as the caption feature, the display form determiner replaces the explanation about sound by characters indicating the sound represented by the explanation about sound.

12. The caption display control system according to claim 11, wherein the display form determiner changes the display form of the characters representing sound obtained by the replacement based on whether a sound source of the sound represented by the explanation of the sound is included in the image as the image feature.

13. The caption display control system according to claim 1, further comprising: a plurality of signal receivers that receive a caption signal, an image signal, and a sound signal of the content, respectively.

14. The caption display control system according to claim 2, further comprising:
an image data extraction processor that extracts characters included in the image indicated by the image signal; and
a conversion processor that converts the characters extracted by the image data extraction processor into the caption signal, wherein
the display form determiner determines a display form of a caption indicated by the caption signal converted by the conversion processor.

15. The caption display control system according to claim 14, further comprising an image signal processor that performs image processing to remove the characters extracted by the image data extraction processor in the image indicated by the image signal.

16. The caption display control system according to claim 2, further comprising:
a sound data extractor that extracts sound indicated by the sound signal; and
a conversion processor that converts the sound extracted by the sound data extraction processor into the caption signal indicating the characters indicating sound, wherein
the display form determiner determines a display form of a caption indicated by the caption signal converted by the conversion processor.

17. A caption display control method executed by a caption display control system, comprising:
extracting a feature of content;
determining a caption display form based on the content feature; and
displaying the caption in the display in the determined display form.
